(19) United States
(12) Patent Application Publication
(10) Pub. No.: US 2013/0101719 A1
(43) Pub. Date: Apr. 25, 2013

(54) PIE MOLD AND METHOD OF FORMING A PIE CRUST

(71) Applicant: Denise R. BROWN, Port Orchard, WA (US)

(72) Inventor: Denise R. BROWN, Port Orchard, WA (US)

(21) Appl. No.: 13/444,067

(22) Filed: Apr. 11, 2012

Related U.S. Application Data
(60) Provisional application No. 61/474,371, filed on Apr. 12, 2011.

(51) Int. Cl. A21C 11/00

(52) U.S. Cl. CPC A21C 11/004
USPC 426/502; 249/204; 426/505; 426/504

(57) ABSTRACT

A pie mold and method of making a pie crust that includes a rigid base and a flexible lid. The rigid shallow base includes a bottom plate and a side wall that forms a cavity of a size to correlate to a conventional pie or tart pan. The lid is placed atop the base to cover the dough-filled cavity and then the filled pie mold is chilled. Once the dough is sufficiently chilled, the dough is transferred to a conventional pie plate for baking. The pie mold may further include one or two optional non-stick liners that are positioned atop the bottom plate and upon which or in between which the dough is shaped. The liners are used to transfer the chilled and shaped pie dough to the pie pan, and peeled off prior to placing the pie dough into the pie pan and/or baking the pie crust.

### RELATED APPLICATION

This application claims priority to U.S. Provisional Patent Application Ser. No. 61/474,371, filed Apr. 12, 2011, and entitled “Pie Mold and Method of Forming a Pie Crust.”

### TECHNICAL FIELD

The present invention relates to an improved pie mold for forming a pie crust and a method for an improved process for shaping dough for a pie crust. The pie mold can also be used for storing and stacking pie crusts.

### BACKGROUND OF THE INVENTION

Pie making is an art form. The medium is dough. After generations of tradition and years of practice artisans are often able to consistently make their pie dough into proper shape and thickness and minimal mess to produce a quality crust. For the novice and sometimes the experienced, crusts often fall apart because of difficulty of moving dough from disk shape to roll out on counter then finally to the pie pan.

Many techniques and inventions have arisen over years to try to combat the difficulties encountered in the creation of a quality pie crust, but none of them takes a baker from pea-sized crumbs of dough to crust lined pan with ease, consistency, lack of waste, minimal mess, and means of storing pie crust for future use as this invention does.

Traditionally when the ingredients for pie crust are mixed they are worked into a disk of dough. This disk is then wrapped in plastic wrap and chilled (e.g., refrigerated) for about an hour. The disk is then placed on a counter to soften enough to roll out the disk on a floured surface. It is then rolled into a sheet into the approximate size of the desired crust. An experienced pie baker can form a crust that is close to the needed depth and diameter without too many mishaps, but even the most seasoned veteran often ends up with inconsistent depth and insufficient coverage of the pie plate requiring repair.

Some patents have attempted to deal with pie crust making challenges. Some have created a crust shaping cavity, but assume wasted flour and plastic wrap. These inventions often must connect to ancillary apparatus which requires separate storage. Finding a single container into which dough can be poured/placed into, rolled into shape, stored and easily placed on a pie plate has proven elusive.

### SUMMARY OF THE INVENTION

The present invention is directed to an improved pie mold and a method for an improved process for shaping, containing, and storing pie dough. The invention includes a rigid shallow and a flexible upper lid. The base has a bottom plate, having an interior and exterior surface, and a side wall. The bottom plate interior surface and side wall form a cavity of a size and shape to contain dough. The base opening is of a size to contain dough that when rolled or pressed across the interior surface bottom plate of the base, that such dough will fit into the bottom of a traditional pie pan.

The flexible lid is sized to cover the base cavity to close the cavity when desired, such as when dough is being chilled, frozen, or otherwise stored.

According to one embodiment, the bottom exterior surface has non skid properties, whether the exterior surface itself is made of a non-skid or skid-resistant material or that an additional material, such as a scored rubberized bottom is applied to the bottom exterior surface.

According to another embodiment, the flexible lid may be made of a flexible non-skid material that can lay flat or essentially flat to at least provide a planar surface that can accommodate the bottom exterior surface of the base plate. In this manner, the flexible lid is positioned below the base and to act as a non-skid surface when the dough is to be shaped within the base.

According to another embodiment of the invention, the pie mold may further include a non-stick liner that is of a shape to cover the interior surface of the bottom plate. In another form of the invention, the pie mold may further include two non-stick liners.

According to another embodiment, the pie mold of the present invention is designed to be stackable atop a second or subsequent pie molds like that of the first pie mold. Also the invention encompasses pie molds of varying sizes to accommodate various pie pan shapes, such as 8, 9, and 10-inch pie and tart pans.

The invention also includes an improved pie dough making process in which pea-gravel size dough is put into the base cavity of the pie mold as discussed above. Prior to filling the cavity with the pea-gravel size dough, the base may be pre-chilled. The pea-gravel size dough is then rolled or patted or otherwise shaped to cover the base interior surface of the bottom plate.

According to another aspect of the invention, the non-stick liner is placed into the chilled base atop of the interior surface of the base's bottom plate. The base cavity is filled with the pea-gravel size dough and shaped as described above. The flexible lid, as described above, is then placed over the base and covered dough and placed in a refrigerator for chilling. The base, dough, and lid may be also stored in the freezer for long-term storage. If many pies are to be made, several pie molds can be used to store and stack sufficient pie dough in a refrigerator or freezer for future needs.

Another embodiment of the inventive method includes adding a second non-stick liner where the one liner is placed below the dough and the other liner is placed atop of the dough prior to rolling the dough out to fit the base interior surface of the bottom plate.

When a dough-filled pie mold is removed from refrigeration, it contains a fully chilled and shaped crust that is easy to work with and can be placed directly into a conventional pie pan (bottom crust), or on top of a filled bottom crust (top crust). The optional non-stick liner(s) can aid the baker in removing the chilled and shaped pie dough from the pie mold base to minimize tearing. A filled pie mold can be taken from the freezer but allowed to defrost, such as in the refrigerator, so that the pie dough is chilled, but will not crack when coming directly from the freezer.

These and other advantages will become more apparent upon review of the Drawings, the Detailed Description of the Invention, and the Claims.

### BRIEF DESCRIPTION OF THE DRAWINGS

Like reference numerals are used to designate like parts throughout the several views of the drawings, wherein:

FIG. 1 is a perspective view of a first embodiment, pie mold of the present invention having a rigid shallow base having a side wall, with an optional ridge externally protruding from the side wall, and a flexible lid;

FIG. 2 is a front view of the pie mold base;.

FIG. 3 is a section view taken substantially across lines 3-3 of FIG. 2 and with pea gravel size pie dough inserted into the cavity of the base;

FIG. 4 is an assembled section view of the pie mold;

FIG. 5 is a view like that of FIG. 4 except illustrating an alternate lid;

FIG. 6 is a view like that of FIG. 5, except where base further includes a flange extending outwardly from the upper edge of the side wall in lieu of the ridge of FIG. 4;

FIG. 7 is an unassembled perspective view of a second alternate embodiment of the pie mold having a rigid shallow base and a flexible lid of the first embodiment pie mold and also having one or two flexible non-stick liner(s) that conform to the interior of the base;

FIG. 8 is front section view like that of FIG. 4 except illustrating where the lid is positioned below the base and atop a work surface to keep the base from skidding or sliding when working (e.g., rolling) the dough relative to the work surface;

FIG. 9 is a view like that of FIG. 8, except illustrating the alternate lid embodiment illustrated in FIGS. 5 and 6;

FIG. 10 is a bottom perspective view illustrating the bottom plate exterior surface of the pie mold base having non-skid properties;

FIG. 11 is an unassembled bottom perspective view of an second alternate pie mold base having a separate but adhered non-skid member;

FIG. 12 is a side view of the assembled second alternate pie mold base of FIG. 11;

FIG. 13 is a flow chart of a method of making a pie crust according to the invention;

FIG. 14 is a flow chart of a first alternate method of making a pie crust;

FIG. 15 is a flow chart of a second alternate method of making a pie crust;

FIG. 16 is a perspective view of pea-gravel size pie dough crumbs;

FIG. 17 is a perspective view of pouring the pea-gravel size pie dough crumbs into the cavity of the pie mold base;

FIG. 18 is a perspective view of working the dough crumbs to form a flattened mound of dough atop of an optional non-stick liner;

FIG. 19 is a perspective view of the flattened mound of dough positioned between two optional non-stick liners prior to shaping (e.g., rolling);

FIG. 20 is a perspective view of shaping (here, rolling) the dough between two non-stick liners with the dough shown in partial cutaway to fill the pie mold base cavity via a rolling pin;

FIG. 21 is a perspective view of the optional liner and pie dough crust fully shaped within the pie mold;

FIG. 22 is a front section view taken along lines 22-22 of FIG. 21;

FIG. 23 is a perspective view of an additional optional step of working the dough by hand from dough crumbs to larger dough clumps prior to forming a flattened mound out of the dough;

FIG. 24 is a front section of an assembled pie mold of the second embodiment having its cavity filled with pie dough crust ready to be chilled;

FIG. 25 is a front section view of stacked pie molds and pie dough for long term storage (e.g., for freezing in a freezer);

FIG. 26 is a perspective view of the pie dough crust separated from the base and about to be transferred to a conventional pie or tart pan;

FIG. 27 is a perspective view of the pie dough crust being transferred to a conventional pie or tart pan;

FIG. 28 is a front section view of the pie dough crust being transferred to a conventional pie or tart pan;

FIG. 29 is front section view of the pie dough crust fully transferred to the conventional pie or tart pan;

FIG. 30 is an unassembled perspective view of various sized pie molds of the present invention being nested during non use; and

FIG. 31 is an assembled section view of the several various sized and nested pie molds.

### DETAILED DESCRIPTION OF THE INVENTION

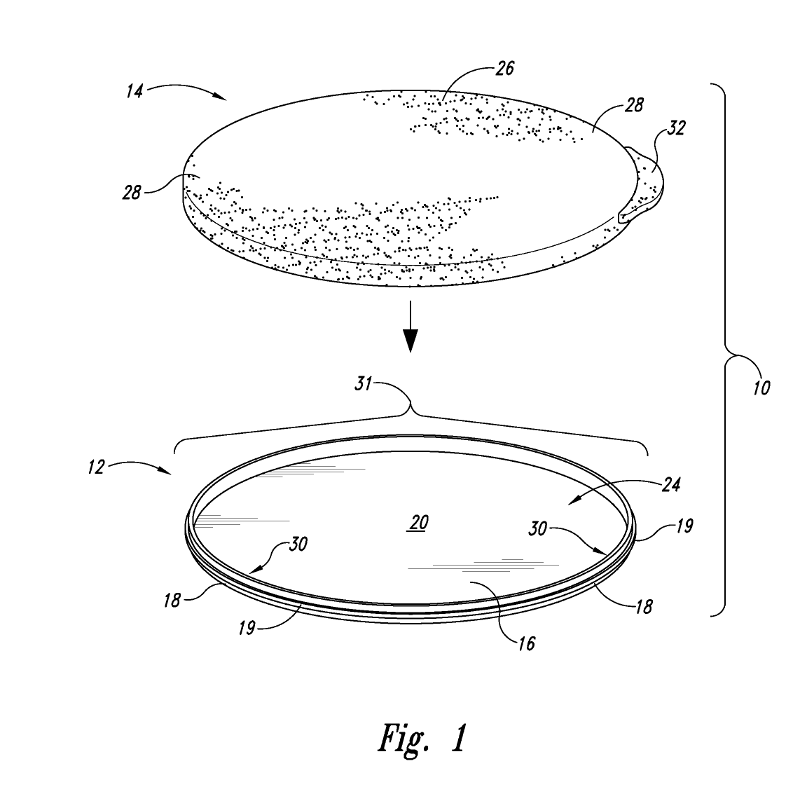

Referring to FIGS. 1-6, an improved pie mold 10 includes a substantially rigid shallow base 12 and a flexible lid 14. The base includes a bottom plate 16 and a side wall 18. Bottom plate 16 includes an interior surface 20 and an exterior surface 22. The interior surface of the bottom plate 20 and the side wall 18 for a cavity. 24 in which to hold pie dough.

An optional external ridge 19 (illustrated in FIG. 1) or non-contiguous external protuberances (not illustrated) may extend outwardly from side wall 18. The significance of such ridge (or protuberances) is discussed further below.

In one form of the invention, the base is substantially round where the bottom plate 16 diameter corresponds to a conventional pie pan (illustrated in FIG. 28 and designated with numeral 50). The cavity 24 is of a size to hold sufficient dough to fill a top or bottom of a conventional pie pan. For example, an 11-inch diameter pie mold base would correspond to a bottom crust for a 9-inch diameter pie pan. A 10-inch diameter pie mold base would correspond to a top crust for a 9-inch pie pan. The pie mold of the present invention would be similarly adapted to various sized pie pans (e.g., 10, 9, 8-inch diameter pans or for various sized tart pans).

Flexible lid 14 is designed to cover over base 12, about optional ridge 19, thereby forming an enclosed structure in which cavity 24, and any contents stored within cavity 24, are protected from dirt or other contaminants. Lid 14 includes top member 26 having generally round outer edges 28 that conforms to cover the upper portions 30 of base side wall 18 generally about base perimeter 31. In this way, the base perimeter 31 is slightly less than the perimeter of the lid. In one form of the invention, outer edges conform over the ridge 19 or other external protuberance to better close the lid about the base to form a seal to make the pie mold cavity generally air tight when the flexible lid is closed over the top of the rigid base.

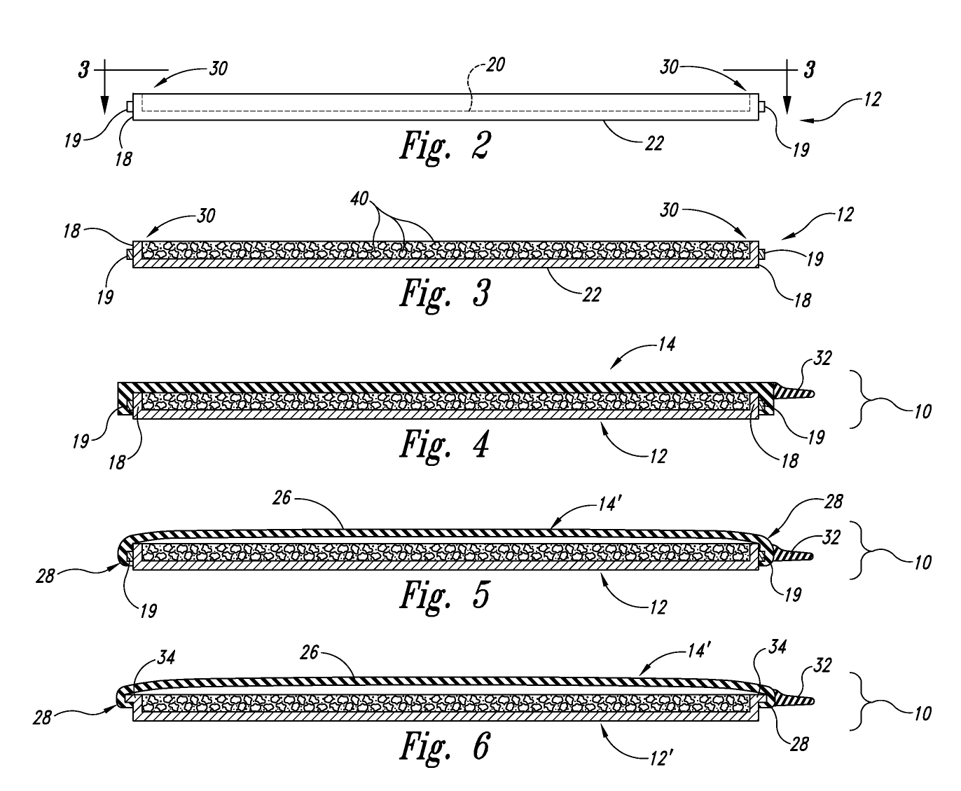

Top member 26 may be essentially planar as shown in FIGS. 1-4 or more malleable as part of a first alternate embodiment lid 14′ as illustrated in FIG. 5. The malleable top member 26 of lid 14′ may stretch and flatten out when something is put atop of it. Lid 14 or 14′ may further include a flange or lip 32 that can overlay and cover the upper portion 30 of the side wall 18 of rigid base 12.

Referring to FIG. 6, pie mold 10 may also include a flange or lip 34 that extend outwardly of the upper portion 30 of the side wall 18 in lieu of ridge 19. The outer edges 28 of lid 14′ then conform to cover flange 34 of the base during chilling or long term storage of the pie mold and dough or general storage of the pie mold during when not in use.

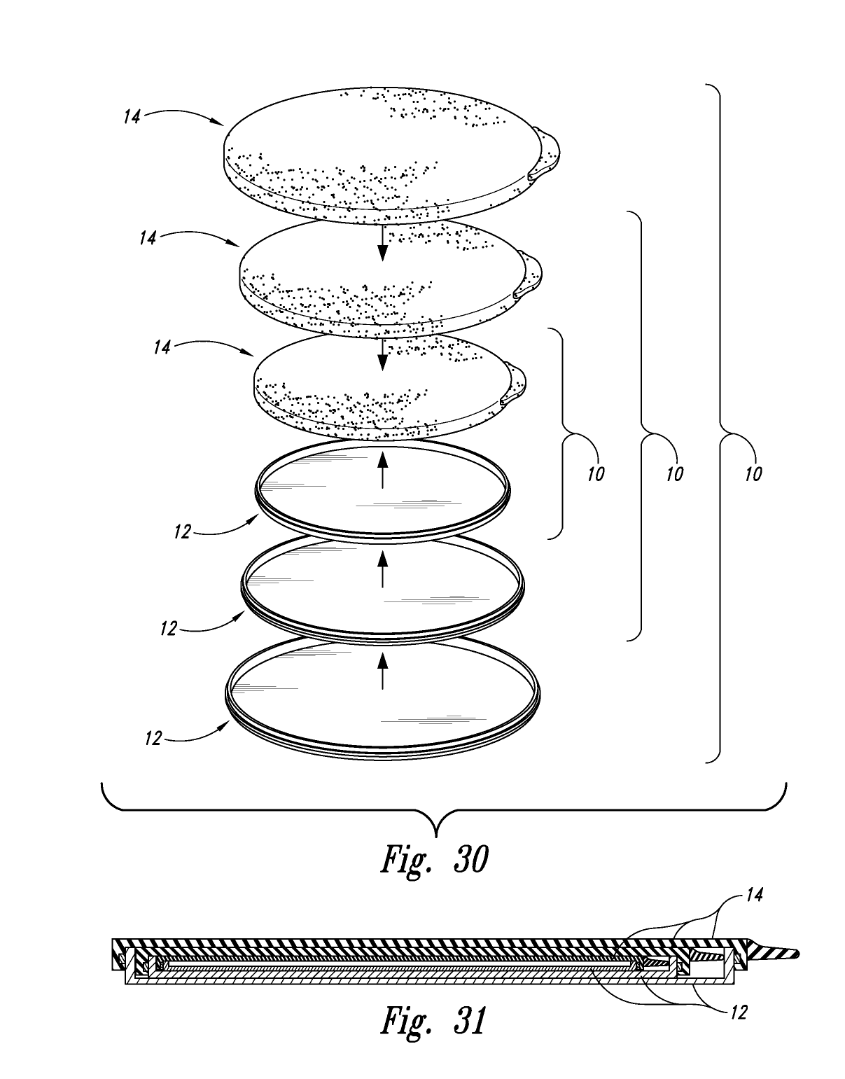

When assembled, the flexible lid 14, 14′ and rigid base makes stacking multiple pie molds atop of each other (see e.g., FIG. 25) for easier whether stored in a cabinet, refrigerator, or freezer. In non use, the various sized pie molds may be stacked like nesting dolls for even easier storage (e.g., FIGS. 30 and 31). Flexible lid may be made from a synthetic or rubberized material that can be safely stored in a refrigerator or freezer.

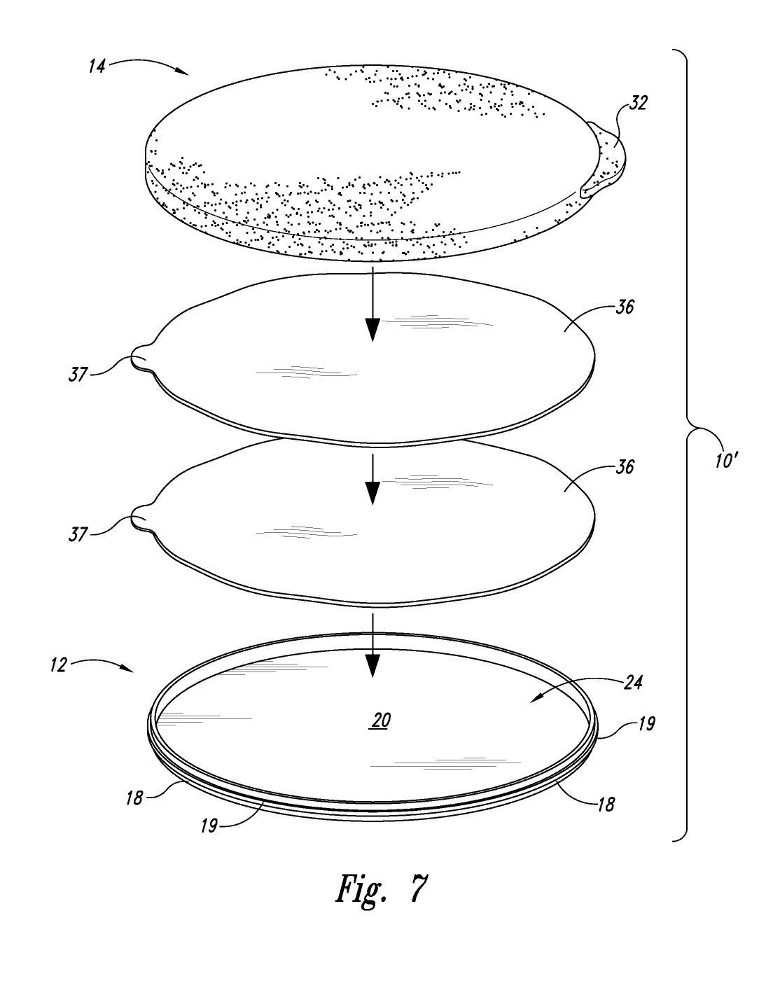

Referring now to FIG. 7, a second alternate embodiment pie mold 10″ is illustrated. Pie mold 10″′ may be like that of pie mold 10, but may further include one or two non-stick liners 36 that conforms to the interior surface 20 of the base bottom plate 16. Liner 36 is a flexible thin member and may be placed atop of the bottom plate of the base. Liner 36 may include an optional liner flange 37. In use, pie dough would be placed atop of a single liner or between two liners. Liner 36 may be made from a synthetic or rubberized material that, similarly to lid 14, can be safely stored in a refrigerator or freezer, as well as a cabinet or other storage place.

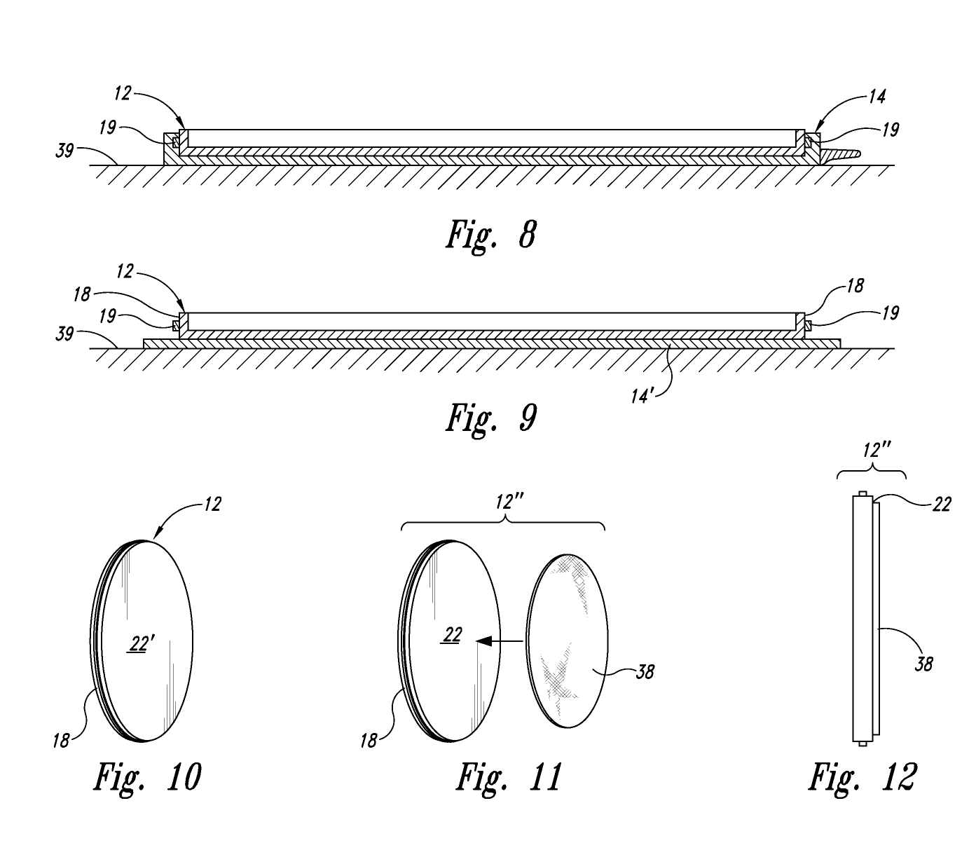

The invention can have optional non-skid characteristics when the dough is to be shaped and generally worked. One option can be seen in FIGS. 8 and 9 where flexible lid 14, 14′ may be used as a non-skid surface positioned underneath base 12 when the pie dough is being worked in order to keep the base from movement relative to a work surface 39, such as a counter top or a table. Other alternatives can be seen in FIGS. 10-12 where base 12 may include a non-skid exterior surface 22′ (FIG. 10) or where a second alternate base 12″ may include a separate non-skid planar member 38 that is affixed (e.g., adhered) to the base bottom plate exterior surface 22 (FIGS. 11 and 12).

The present invention also includes a method of making a pie crust using the pie mold described above (also including the variants described above) in order to make a pie crust that requires less effort, less mess, and still provides the superior qualities of a homemade crust.

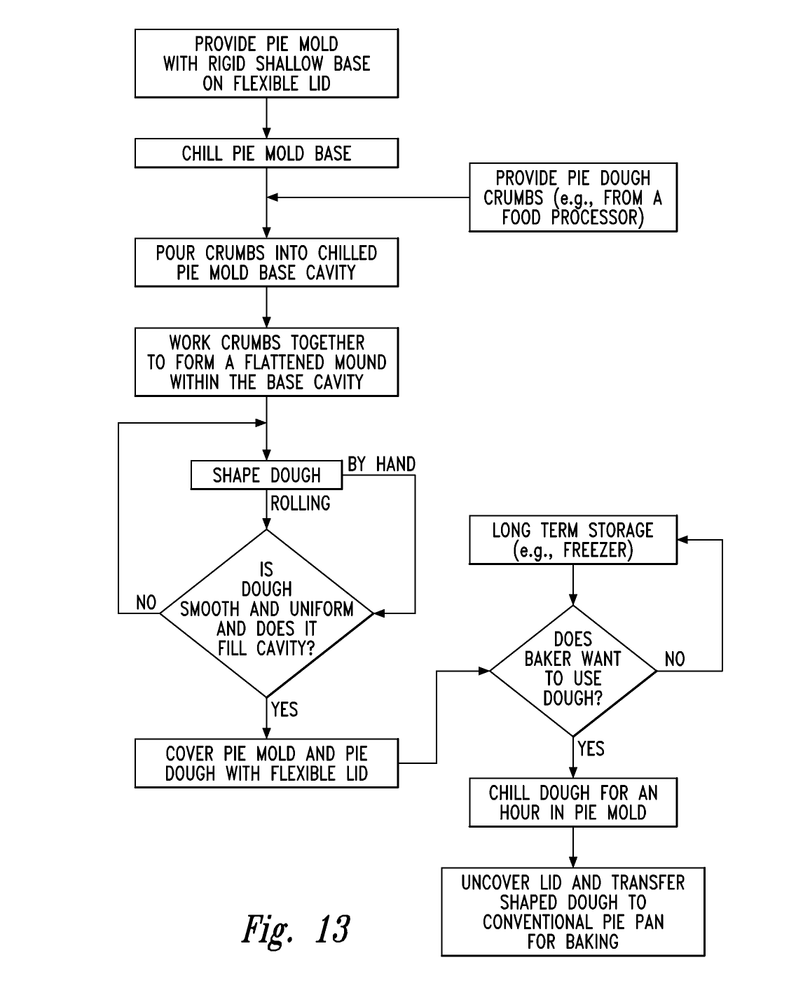

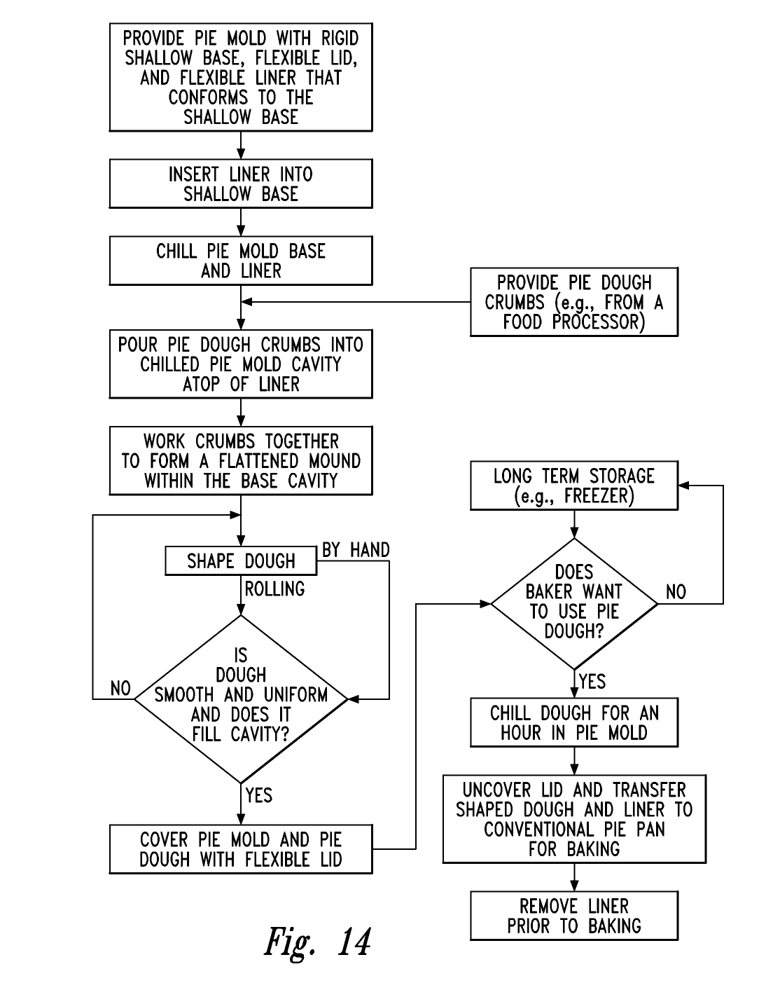

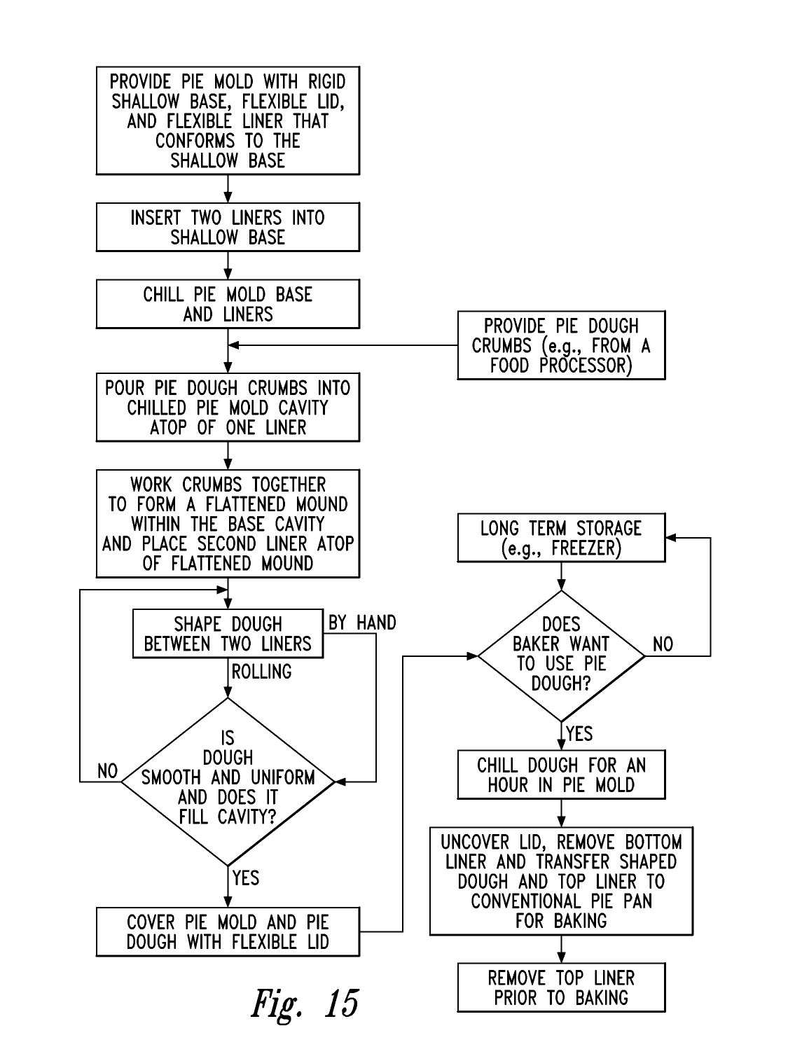

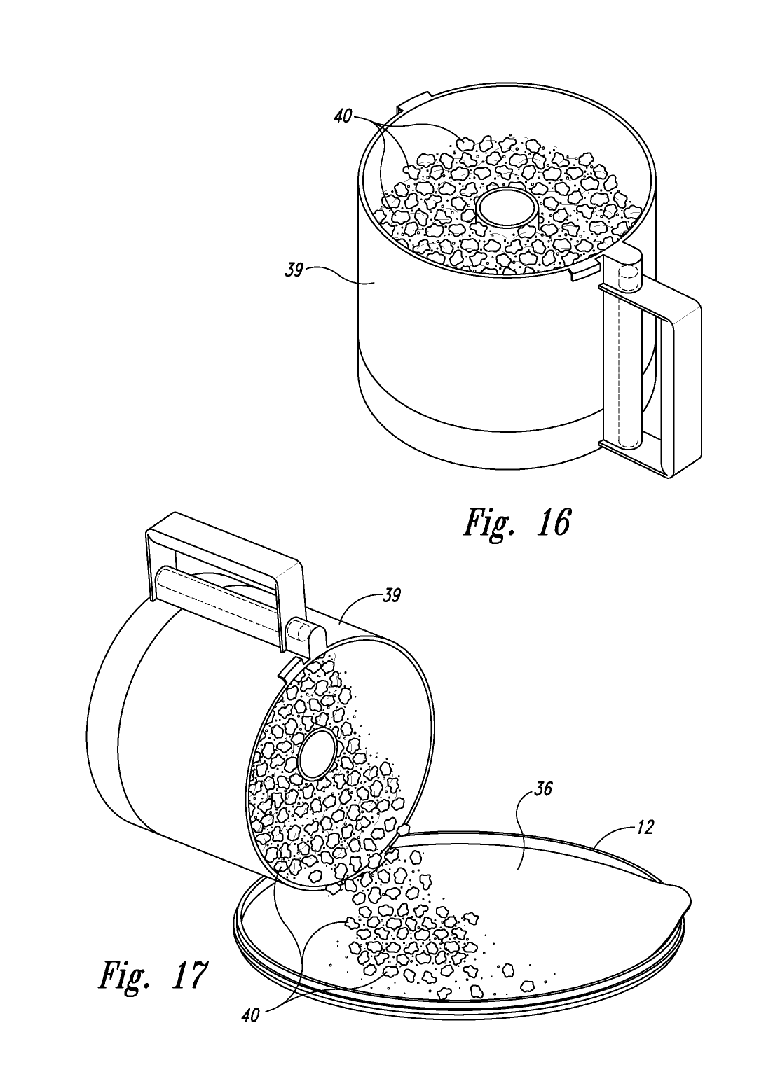

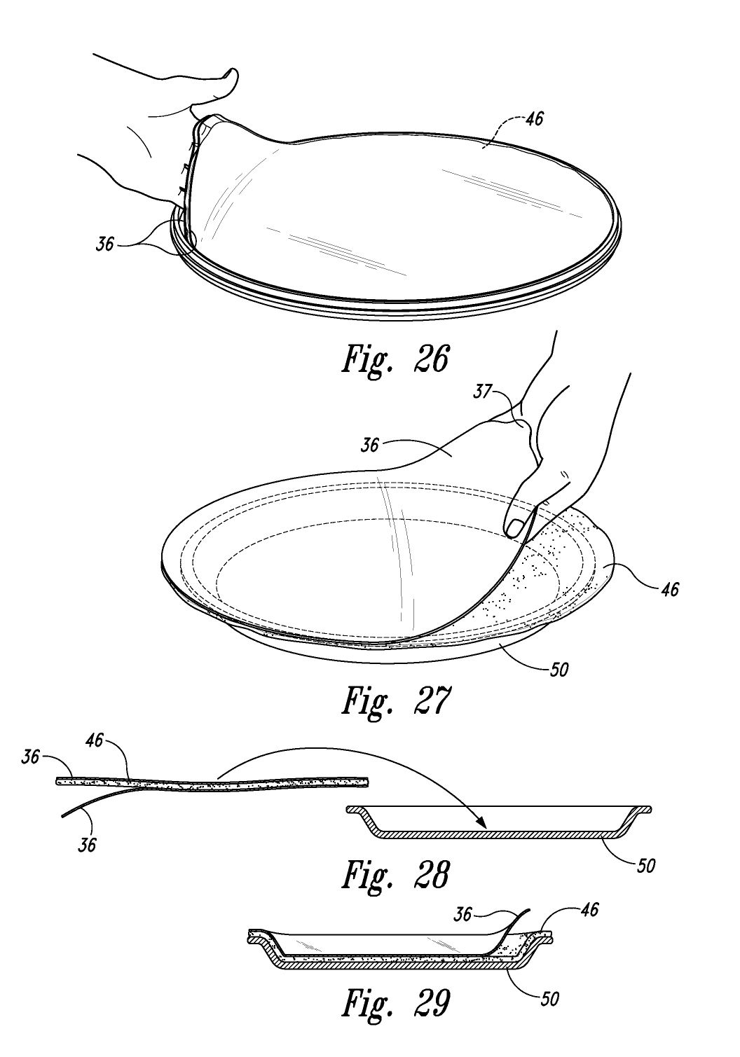

Referring to the flowchart of FIGS. 13 and 15 and the illustrations of FIGS. 16 to 29, the method of the present invention includes taking pea-gravel size pie dough crumbs and shaping them to conform to fit a conventional pie or tart pan with maximum efficiency and minimal mess (the lack of efficiency and large mess being the biggest barriers to home cooks baking pies at home under the current known ways to make pie crusts).

Pie crusts are made from combining flour, fat, and a small amount of liquid, the recipes of which are numerous and varied and well-known to the skilled and unskilled alike. It is not the intention of Applicant to wade into the controversial waters of what constitutes the best pie dough. Suffice to say that it is the combination of flour, fat (whether butter, shortening, or lard), and a small amount of liquid (generally cold water) and many well-known recipes for pie crusts exist in easy-to-access places. The method of forming a pie crust using the pie mold of the present invention will work well with any of the well-known pie crusts, despite the recipe and type of fat used.

Mixing is also a controversial matter and either hand'mixing (pastry cutter or a pair of knives will work well). However, the advent of food processors 39 (e.g., FIG. 16), such as those made by CUISINART, make combining flour, fat, and water much easier and less mess to clean up.

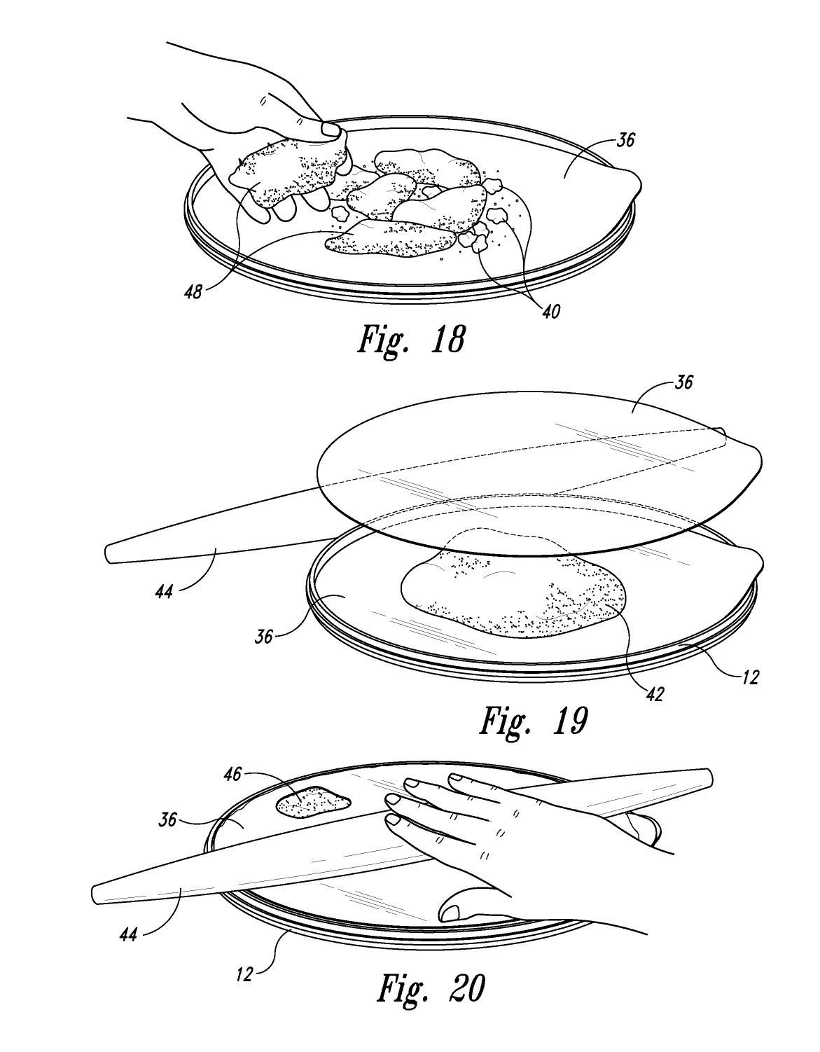

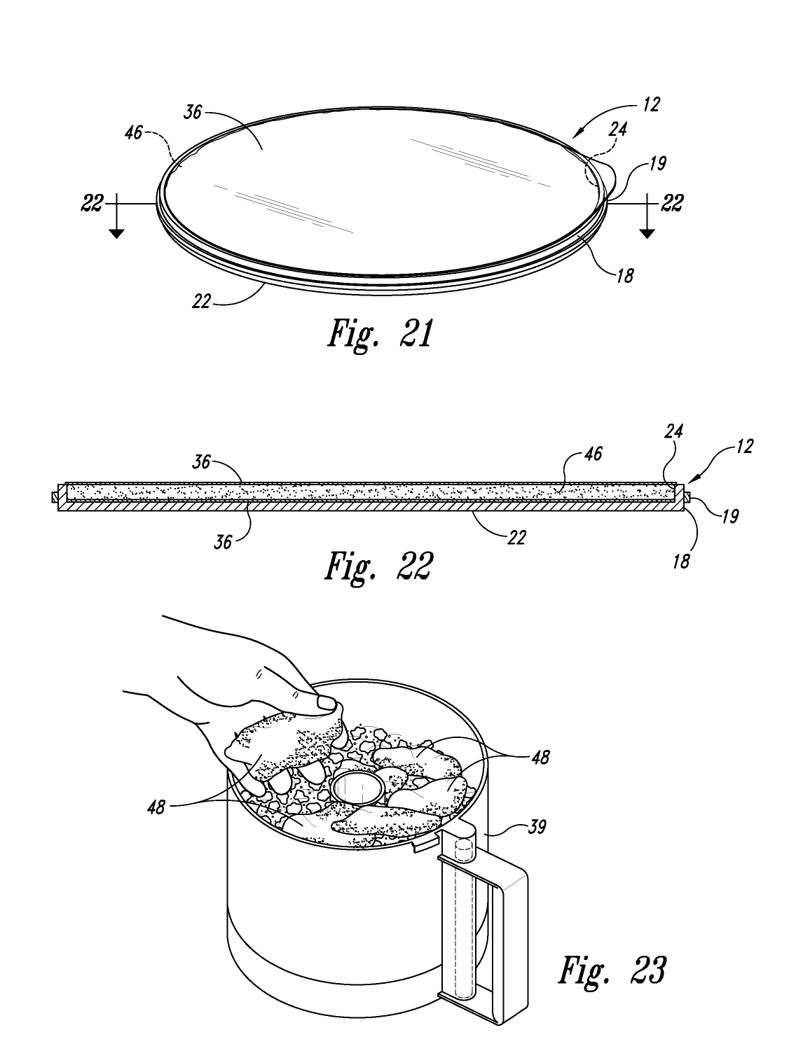

Once the flour, fat, and water are processed or otherwise mixed (e.g., pastry blender tool or a pair of knives) to form pea-gravel size crumbs 40 of pie dough (FIG. 16), crumbs 40 are placed in the pie mold base 12 (FIG. 17). The crumbs 40 are manually compressed (FIG. 18) to form a flattened mound 42 (FIG. 19). From there, the dough is shaped to fill the entire pie mold cavity 24 until the dough is smooth and uniform. This final shaping can be done by a rolling with a rolling pin 44, as illustrated in FIG. 20 between the two optional liners 36, to create a fully shaped by pie crust 46 (FIGS. 21 and 22) or pressing out the pie crust by hand to fill the pie cavity (not illustrated).

Alternatively, crumbs 40 may be further worked by hand as an interim step all within the base (FIG. 18) to form larger dough clumps 48. This extra step has provided the Applicant with a lighter and flakier crust in the past, both of which are desired crust elements.

Again referring to FIGS. 8 and 9, during shaping the pie mold base is positioned atop a planar work surface 39, such as a counter top or table. The flexible lid may be positioned underneath the mold between the pie mold base and the planar surface to provide a non-skid surface and can generally keep the pie mold from lateral movement during the pie shaping step. Alternatively, the pie mold may include a non-skid bottom surface or a separate non-skid bottom member 38, such as those alternative embodiments discussed above and illustrated in FIGS. 10-12.

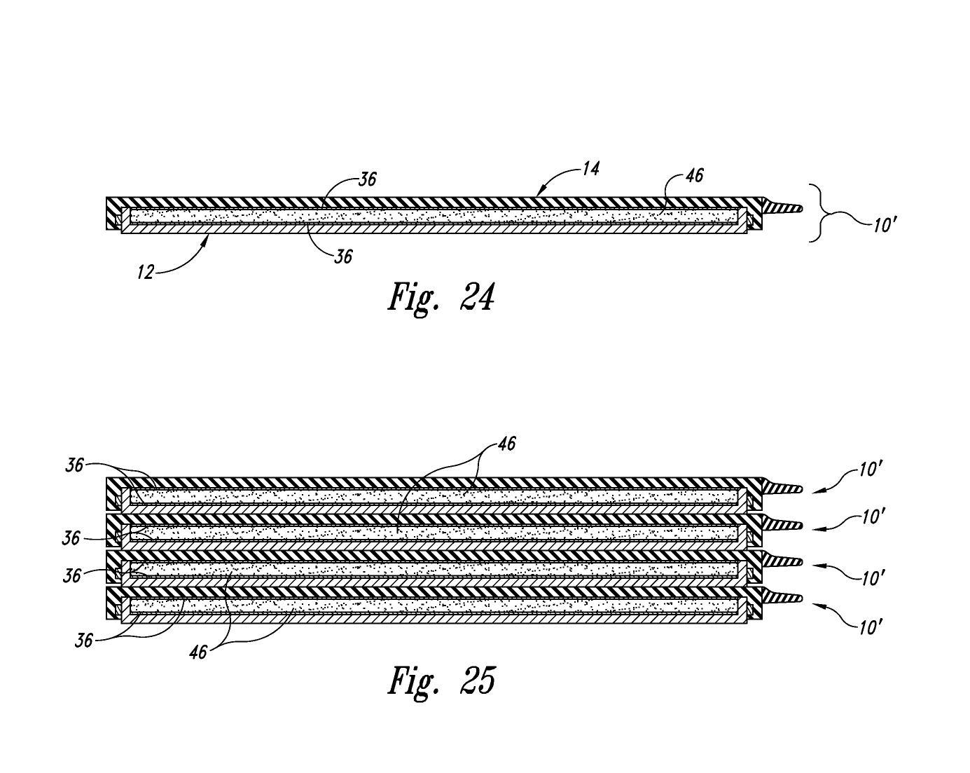

Referring again to FIG. 20-22, the pie dough is fully shaped when it completely or substantially completely fills the pie mold cavity 24. The resulting pie dough crust 46 should be substantially uniform and smooth. The lid 14 is then placed over base 12 to create a generally airtight enclosure for the pie dough crust 46 (FIG. 24). The pie mold and encased dough is then chilled for approximately one hour if the pie crust is to be baked reasonably soon thereafter. If the pie crust is not needed for a while (e.g., advance baking for holiday preparations), the pie mold and dough may be stored in a freezer for many, months. Multiple pie crusts may be made at one time and stored, one to a pie mold, and stacked one atop the other as illustrated in FIG. 25.

According to another embodiment of the present invention, the pie dough may be placed into a pre-chilled pie mold.

According to another embodiment of the invention, the optional liner 36, such as that described above and illustrated in FIG. 7, may also be used and the same steps as described above are used except that the dough is placed into the base 12 of pie mold 10′ with the liner 36 already in place atop of the base bottom plate.

When the pie dough is ready to be baked, the pie mold 10′ and encased dough 46 are removed from the refrigerator. The pie mold lid 14 is removed from the pie mold base. Referring now to FIGS. 25-28, the chilled and shaped dough 46 is then removed from the base and placed into a conventional pie or tart pan 50. The cold dough is readily released from the pie mold base. The optional non-stick liner 36 makes releasing of the dough even easier as the dough is transferred to the pie. pan 50 and then the liner is then peeled off via the liner flange 37 (partially illustrated in FIG. 27). The pie crust is then ready for pre-baking or for further assembly, such as adding a fruit or cream filling—without or without a top crust.

A top crust would be made the same way in a separate pie mold, albeit one that is slight larger (e.g., a 10-inch diameter pie mold for a top crust for a 9-inch diameter pie pan).

One of the benefits of the present pie mold invention and method is the ease of making and ease of clean-up. The metal base unit and flexible lid (lid being either rubber, plastic, or a composite) are intended to be freezer safe and upper rack dishwasher safe. When not needed, various sized pie molds can be nested for easier storage (FIG. 30 and FIG. 31).

The present invention reduces waste by eliminating the need for plastic wrap and excess flour.

Another benefit is that it is easier to chill the pie mold to provide a chilled surface in which to work, rather than chill an entire counter surface (which may be impractical). Good bakers know that keeping the pie dough chilled is desirable to make dough easy to work with and optimal for obtaining a flakier crust.

The pie mold rigid side wall provides a natural barrier to the overall shape of the pie crust and eliminates the need for trimming and excess waste. Further, the same sides act as a secure rolling surface for a conventional rolling pin for the final shaping of the dough. Cracking and breaking which are so common, especially with novice pie makers, are eliminated.

If additional flour is used during the shaping process, it is fully contained by the base unit reducing mess (flour and dough on a conventional countertop is a clean up project) and reduces the amount of flour needed.

Slipping and instability, common complaints in the making of crusts, are eliminated by the ability to affix the flexible lid to the underside of the base unit during the molding process.

Further, there is no need for separate storage containers or plastic wrap for chilling or storage as the lid can serve two functions: first, as a non-stick surface so that the pie mold base is not moving laterally during shaping and second, to serve as a lid for the pie mold base for airtight or nearly airtight storage.

The illustrated embodiments are only examples of the present invention and, therefore, are non-limitive. It is to be understood that many changes in the particular structure, materials, and features of the invention may be made without departing from the spirit and scope of the invention. Therefore, it is the Applicant's intention that her patent rights not be limited by the particular embodiments illustrated and described herein, but rather by the following claims interpreted according to accepted doctrines of claim interpretation, including the Doctrine of Equivalents and Reversal of Parts.

I claim:

1. A pie mold comprising:
a rigid planar base having a rigid shallow side wall and a bottom plate forming a perimeter, said bottom plate having an interior surface and an exterior surface; said side wall and interior surface of the bottom plate forming a cavity of a size and shape correlate to a conventional pie pan;
a flexible lid that fits atop the base and capable of enclosing the cavity.

2. The pie mold according to claim 1 further comprising a ridge externally protruding from the perimeter of the base side wall.

3. The pie mold according to claim 1 further comprising at least one thin, planar, flexible, non-stick liner of a side a shape to conform to the base cavity atop of the interior surface of the bottom plate.

4. The pie mold according to claim 1 wherein the exterior surface of the bottom plate includes a non-skid material.

5. The pie mold according to claim 3 wherein the exterior surface of the bottom plate includes a non-skid material.

6. The pie mold according to claim 1 wherein the pie mold base and lid are substantially round in shape.

7. The pie mold according to claim 3 wherein the pie mold base, lid, and the at least one liner are all substantially round in shape.

8. The pie mold according to claim 1 where the flexible lid is made of a non-skid material that can lay essentially flat when the base bottom plate is set atop of the lid.

9. A method of making a pie crust the method comprising:
providing a pie mold having a rigid shallow base having a cavity of a size and shape to conform to a conventional pie pan and a flexible lid that can cover the base to enclose the cavity;
providing combined ingredients of a pie dough recipe still in crumb form;
pouring the pie dough crumbs into pie mold base and shaping the dough to fill the pie mold cavity;
placing the lid over the pie mold base and dough and chilling the dough encased pie mold;
taking the chilled and shaped dough and transferring it to the Conventional pie pan for subsequent baking.

10. The method according to claim 9 further comprising the step of chilling the base prior to the pouring the pie dough crumbs into the base.

11. The method according to claim 9 further comprising the step of working the dough by hand from crumbs to clumps after the crumbs are poured into the pie mold base but prior to shaping the dough to file the pie mold cavity.

12. The method according to claim 9 further comprising the step of applying the lid to the base in an air-tight manner.

13. The method according to claim 9 wherein the flexible lid consists of a non-skid material and further comprising the step of placing the flexible lid atop a planar surface and placing the base atop of the lid when the dough is being shaped within the base.

14. The method according to claim 9 wherein shaping the dough is accomplished via a rolling pin.

15. The method according to claim 9 wherein shaping the dough is accomplished by pressing the dough by hand to fill cavity.

16. The method according to claim 9 wherein the pie mold further includes a non-stick liner that is placed atop of the interior surface of the bottom plate and further comprising the steps of placing the dough over the liner and removing the chilled dough and liner from the base when transferring the pie dough to the conventional pie pan and peeling off the liner from the chilled pie dough prior to baking.

17. The method according to claim 9 wherein the pie mold further includes two non-stick liners that are placed atop of the interior surface of the bottom plate and further comprising the steps of placing the dough between the two liners and removing the chilled dough and liners from the base when transferring the pie dough to the conventional pie pan and peeling off the bottom liner before the pie dough is placed into the conventional pie pan and removing the top liner from the chilled pie dough prior to baking.

18. A method of making a pie crust the method comprising:
providing a round pie mold having a rigid shallow base having a cavity of a size and shape to correlate to a conventional pie pan, a round liner of a size and shape to conform to the base, and a flexible lid that can cover the base to enclose the cavity;
providing combined ingredients of a pie dough recipe still in crumb form;
pouring the pie dough crumbs into pie mold base atop of the liner and working the crumbs into larger dough clumps;
working the dough to create a flattened mound;
shaping the flattened mound of dough to fill the pie mold cavity;
placing the lid over the pie mold base and dough and chilling the combined dough and pie mold;
transferring the chilled and shaped dough and liner into the conventional pie pan and removing the liner prior to baking.
